(19) United States
(12) Patent Application Publication
(10) Pub. No.: US 2019/0346981 A1
(43) Pub. Date: Nov. 14, 2019

(54) AUTOMATED EXPERIENCE CREATION ENGINE

(71) Applicant: GameCommerce, Inc., Sunnyvale, CA (US)

(72) Inventors: Jayaprakash Pasala, Rocklin, CA (US); Sudhir Subramanian, San Ramon, CA (US); Andrew Jasper, San Diego, CA (US); Nagesh Pobbathi, San Jose, CA (US)

(21) Appl. No.: 15/978,034

(22) Filed: May 11, 2018

(51) Int. Cl. G06F 3/0484; G06F 17/30

(52) U.S. Cl. CPC G06F 3/0484; G06F 3/04842; G06F 17/30126

(57) ABSTRACT

A method for creating a computer-based experience is provided. The method includes receiving at least one input file having design information regarding a computer-based experience. The method further includes automatically extracting the design information from the at least one input file. The method further includes automatically generating design components using the design information. The method further includes creating, using the design components, a customized computer-based experience.

### BACKGROUND

### Field

This application is generally directed to systems, apparatus, and methods for creating and disseminating computer-based experiences to allow individuals to interact with the computer-based experiences via the individuals' computing devices.

### Description of the Related Art

Various companies are interested in creating a variety of computer-based experiences (e.g., games; videos; informational or educational presentations; advertisements; microsites; webpages; other mono- or bi-directional communications) for individuals (e.g., consumers; current customers; potential customers; former customers; current or potential employees; agents) to provide these individuals with information (e.g., regarding the company, the company's brand, and/or its competitors and their brands). These experiences can be used by the company in its advertising and/or other marketing and brand building activities whereby the individuals interact with the computer-based experience via the individual's computing device (e.g., smartphone; tablet; personal computer).

The creation of these experiences using conventional systems is cumbersome, time-consuming, and labor-intensive, typically involving a high degree of design and implementation effort. In addition, if these experiences are desired to be presented to individuals across multiple types of platforms and/or devices (e.g., IOS; Android), the effort to create and publish these experiences can be even more cumbersome, time-consuming, and labor-intensive.

### SUMMARY

Certain embodiments described herein provide a method for creating a computer-based experience. The method comprises receiving at least one input file comprising design information regarding a computer-based experience. The method further comprises automatically extracting the design information from the at least one input file. The method further comprises automatically generating design components using the design information. The method further comprises creating, using the design components, a customized computer-based experience.

Certain embodiments described herein provide a computer system for creating a computer-based experience. The computer system comprises at least one processor in operative communication with one or more user computing devices via the internet and in operative communication with one or more individual computing devices configured to access the computer-based experience. The one or more user computing devices are configured to provide user input to the at least one processor while creating the computer-based experience. The computer system further comprises at least one memory device in operative communication with the at least one processor and operative to store information to be used by the at least one processor and/or generated by the at least one processor and to provide the stored information to the at least one processor. The at least one processor is operative to receive at least one input file comprising design information regarding an initial computer-based experience, automatically extract the design information from the at least one input file, automatically generate design components using the design information, and create, using the design components, a customized computer-based experience.

Certain embodiments described herein provide a non-transitory computer storage having stored thereon instructions that, when executed by a computer system cause the computer system to receive at least one input file comprising design information regarding an initial computer-based experience, automatically extract the design information from the at least one input file, automatically generate design components using the design information, and create, using the design components, a customized computer-based experience.

The paragraphs above recite various features and configurations of one or more methods, computer systems, circuits, and computer storage that have been contemplated by the inventors. It is to be understood that the inventors have also contemplated methods, computer systems, circuits, and computer storage which comprise combinations of these features and configurations from the above paragraphs, as well as methods, computer systems, circuits, and computer storage which comprise combinations of these features and configurations from the above paragraphs with other features and configurations disclosed in the following paragraphs.

### BRIEF DESCRIPTION OF THE DRAWINGS

The foregoing aspects and many of the attendant advantages provided by certain embodiments described herein will become more readily appreciated as the same become better understood by reference to the following detailed description, when taken in conjunction with the accompanying drawings.

FIG. 1 is a flow diagram of an example method for creating a computer-based experience in accordance with certain embodiments described herein.

FIGS. 2A and 2B show two example flow diagrams for an example design extraction engine in accordance with certain embodiments described herein.

FIG. 3A is an example flow diagram of an example creation engine in accordance with certain embodiments described herein.

FIG. 3B shows example code of an example json file for rendering the user interface to specify a customizable logo on a start screen of the computer-based experience in accordance with certain embodiments described herein.

FIGS. 4A-4E show example views of an example user interface for modifying a computer-based experience in accordance with certain embodiments described herein.

FIG. 5 is a flow diagram of an example method for creating and disseminating a computer-based experience in accordance with certain embodiments described herein.

FIGS. 6A-6B show example computer code for a published trivia game in accordance with certain embodiments described herein.

FIG. 7 schematically illustrates an example computer system for creating a computer-based experience in accordance with certain embodiments described herein.

FIG. 8A shows an example of game code corresponding to two text elements and an image element extracted from a Photoshop document in accordance with certain embodiments described herein.

FIG. 8B shows an example of the automatically generated game code in accordance with certain embodiments described herein. The generated game code can then be used for rendering the game.

FIG. 9A shows an example screen, FIG. 9B shows example layers of the example screen of FIG. 9A, and FIG. 9C shows example code automatically generated for the example screen of FIG. 9A and the example layers of FIG. 9B in accordance with certain embodiments described herein.

FIGS. 10A-10E illustrate example screenshots of images for an example method of creating a customized computer-based experience in accordance with certain embodiments described herein.

FIGS. 11A-11F illustrate screenshots of example pages presented to the user in a web browser for creating a customized computer-based experience in accordance with certain embodiments described herein.

### DETAILED DESCRIPTION

Companies may seek to create and publish such computer-based experiences under various scenarios. One example is that a company wants to generate a computer-based experience (e.g., a trivia game) using a predetermined format (e.g., template) but with content tailored to the company's needs and its creative branding. Using conventional systems, the company would have to utilize one or more skilled programmers capable of integrating the content with the template format to build (e.g., develop) and disseminate (e.g., publish) the computer-based experience. Another example is that a company wants to generate a custom computer-based experience (e.g., independent from any predetermined format or template). Using conventional systems, the company would have to utilize a design team to design the computer-based experience and a full-fledged implementation team to implement the design as desired. In addition, under both of these examples, the company would want to ensure that the computer-based experience can be run on any platform and/or device that the individuals can be expected to use when interacting with the computer-based experience, and that the computer-based experience can be easily deployed (e.g., to various advertising agencies; embedded within a microsite) so as to be made accessible to the desired individuals.

For example, with regard to game design, game designers generally prefer to create the game scenery and game elements in design tools such as Adobe Photoshop® software or Adobe Illustrator® software. In such design tools, a game scene or a game screen can include tens or hundreds of elements, which are positioned relative to one another by the game designer to create the game design, taking a long time to do so. The game developer then has to take the elements of the game design and convert them into a playable game. For example, in the conventional game generation process, the game developer must extract all the design elements of a received design file, and must capture the important information (e.g., position; scaling; transparency; visibility) for each of these design elements. The game developer must also spend considerable time translating these design elements and the corresponding information into computer code. In addition, the game developer generally has to go back and forth with the game designer multiple times throughout the process (even for basic screens) to get the game elements positioned and rendered as intended by the game designer. This conventional process generally takes a long time (e.g., 16 weeks).

Certain embodiments described herein advantageously provide an elegant solution to the problems encountered when utilizing conventional systems in creating and publishing computer-based experiences. In certain embodiments, an experience creation platform is provided that is completely cloud-based and self-service (e.g., performed by the user without the involvement of a skilled programmer). The experience creation platform is configured to allow a user relatively unskilled in computer coding or programming (e.g., company marketing personnel) to generate a computer-based experience using the user's predetermined content (e.g., the company's branding content). Certain embodiments described herein advantageously provide a very powerful and extensible platform for users to create powerful cross-platform computer-based experiences that utilize the browser of the individual's computing device and can be fully built on the cloud by the users themselves. While conventional systems generally take weeks to convert a design into an experience (e.g., a game), certain embodiments described herein can automatically extract information from the input design file and generate an experience (e.g., a game) within a few hours (e.g., less than one hour). Certain such embodiments automatically extract all the images and elements (e.g., text elements) and automatically capture detailed information regarding all the design elements of a scene or screen in a game definition, with design elements correctly positioned relative to one another (e.g., within one pixel).

Certain embodiments described herein automatically optimize the design elements for use in generating the experience (e.g., game). For example, having too many images and/or animations can make too many sprite sheets and/or can make the sprite sheets too large, resulting in slower loading of the game and slower performance of the game (e.g., because the processor running the game has to keep swapping the sprite sheets to render a game scene). While smaller images can result in faster game loading and performance, using smaller images can result in the game looking less sharp (e.g., lossy). Certain embodiments described herein automatically optimize the sizes of the images and/or the sprite sheets and the number of images and/or sprite sheets for use in generating the experience (e.g., game). For example, certain smartphone displays have a 16:9 aspect ratio, while others have a 2.1:1 aspect ratio. The sizes of the images in the generated experience can be designed to accommodate these expected aspect ratios (e.g., by keeping height constant; by trimming the left and right sides). As used herein, the term “automatically” has its broadest reasonable interpretation, including but not limited to, being performed by the computer system (e.g., processor) with little or no direct human control or intervention.

In one example scenario, the experience creation platform can comprise a plurality of pre-defined templates (e.g., trivia games; other games) from which the user seeking to generate the computer-based experience can select a template for the computer-based experience, and the user can fully tailor the computer-based experience using the template and the predetermined content (e.g., the company's branding content). In another example scenario, the experience creation platform can receive (e.g., from the user) an input file with information regarding the design of the computer-based experience, can extract all the components from the design, and can automatically generate the appropriate computer code for the computer-based experience (e.g., appropriate computer code to be executed by one or more processors to present the computer-based experience on an individual's personal computing device). In certain embodiments, the user can use the experience creation platform to tweak the computer-based experience (e.g., to add appropriate game play) in a self-service manner (e.g., performed by the user without the involvement of a skilled programmer). In certain embodiments, once the computer-based experience is created, the user can publish a uniform resource locator (URL) to be disseminated and used by individuals seeking to interact with the computer-based experience on the user's personal computing device. In certain embodiments, the experience creation platform is advantageously configured to allow users to create a cross-platform, purely browser-based, brand-specific computer-based experience very quickly and with high quality.

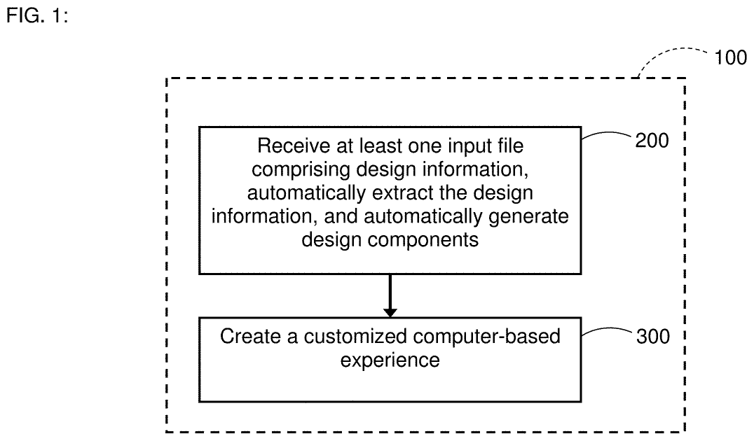

FIG. 1 is a flow diagram of an example method 100 for creating a computer-based experience in accordance with certain embodiments described herein. In an operational block 200, the method 100 comprises receiving at least one input file comprising design information regarding a computer-based experience, automatically extracting the design information from the at least one input file, and automatically generating design components using the design information. In an operational block 300, the method 100 further comprises creating, using the design components, a customized computer-based experience.

In certain embodiments, the computer-based experience comprises one or more games, videos, informational presentations, educational presentations, advertisements, microsites, webpages, or other mono- or bi-directional communications that are configured to be engaged by individuals using their computing devices (e.g., smartphone; tablet; personal computer) via the internet. For example, a computer-based experience can comprise a game designed to be played by consumers to allow these consumers to engage with a company's brands in an enjoyable and memorable manner. For another example, a computer-based experience can comprise a slideshow presented to an individual on the individual's computing device (e.g., as an advertisement or other marketing tool). For still another example, a computer-based experience can comprise a microsite (e.g., one or more web pages within a website of a company seeking to market products/services to consumers) with customizations embedded within the microsite.

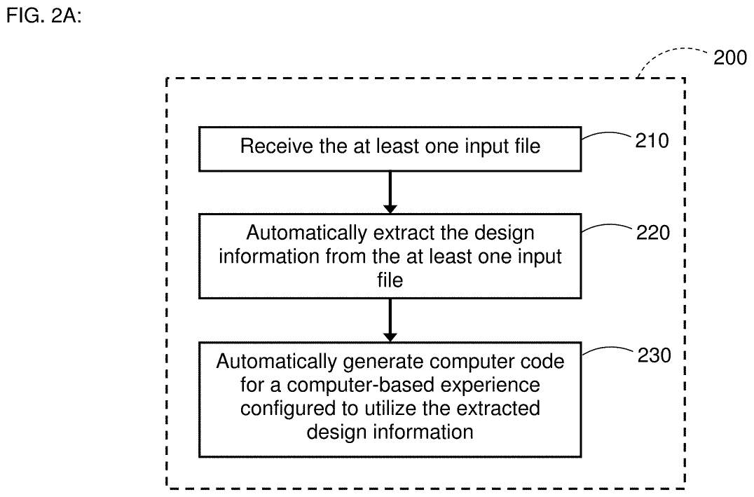

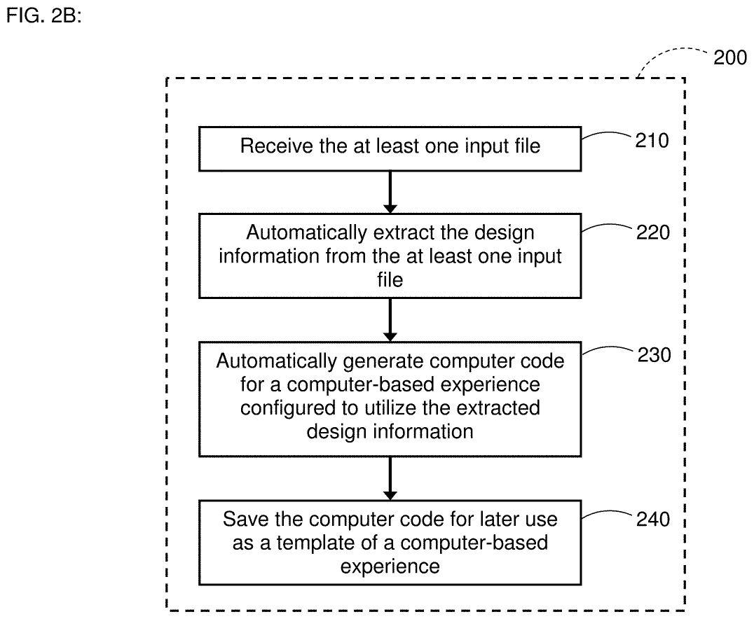

FIGS. 2A and 2B show two example flow diagrams for an example design extraction engine 200, corresponding to the operational block 200 of FIG. 1, in accordance with certain embodiments described herein. The example design extraction engine 200 can be deployed in the cloud, and can be automatically run on the at least one input file. The output of the example design extraction engine 200 can be fed to the creation engine 300 and used to render a user interface as described more fully below.

FIG. 2A shows an example design extraction engine 200 which receives at least one input file provided by the user seeking to create the computer-based experience (e.g., in the operational block 210), automatically extracts the design information from the at least one input file (e.g., in the operational block 220), and automatically generates computer code for a computer-based experience configured to utilize the extracted design information (e.g., in an operational block 230). The example design extraction engine 200 of FIG. 2A can create an initial computer-based experience used in the operational block 300, and can be termed “custom experience creation.” In certain such embodiments, the operational block 300 further comprises receiving user input and, in response to the received user input, modifying the initial computer-based experience to generate a customized computer-based experience.

The example design extraction engine 200 of FIG. 2B is similar to that of FIG. 2A (e.g., including the operational blocks 210, 220, 230), but is used to pre-generate and save computer code for later use as one or more templates of computer-based experiences (e.g., in an operational block 240), and can be referred to as “self-serve experience creation.” In certain embodiments, the operation of the design extraction engine 200 of FIG. 2B is not visible to the user seeking to create the computer-based experience.

In an operational block 210, the design extraction engine 200 receives the at least one input file. For example, the at least one input file can comprise design information regarding one or more design components. The at least one input file can be compatible with various computer formats, including but not limited to, Adobe Photoshop® file format (e.g., psd), GIMP (GNU Image Manipulation Program) file format (e.g., .xcf), Blender 3D creation suite (e.g., obj, fbx, 3ds, ply, stl), Adobe Illustrator® (e.g., ai, pdf, eps, svg, svgz), and Sketch App (e.g., sketch). The at least one input file can have data structures that are known and/or are compatible with one or more application program interfaces (APIs) in one or more programming languages and configured to retrieve detailed information from the input file. For example Gimp and Photoshop input files can include one or more scenes, each comprising multiple layers, with each layer comprising information and the order of the layers being important to make the scene render correctly. Such file formats of the at least one input file are not designed or intended to be used as sources for the automatic extraction of design information (e.g., these file formats do not support a way to provide metadata to be used by an automatic extraction engine to identify design components to be extracted, to facilitate the mapping of design elements to coding elements, or to otherwise guide or facilitate the automatic extraction). Furthermore, such file formats of the at least one input file generally do not have good JavaScript Object Notation (json) support, thereby hindering an automatic extraction which includes conversion of native objects in the file into json elements. In certain embodiments (e.g., FIG. 2A), the at least one file is uploaded by a user during the process of creating the computer-based experience, while in certain other embodiments (e.g., FIG. 2B), the at least one file is pre-loaded (e.g., by the user seeking to create the computer-based experience or by a different user seeking to create a template for later use in creating the computer-based experience).

In an operational block 220, the design extraction engine 200 automatically extracts the design information from the at least one input file. The at least one input file of certain embodiments comprises design information regarding one or more design components, including but not limited to, image components, scalable vector graphic (SVG) components, text components, tween components, animation components, physics components, and augmented reality (AR) components.

For example, for extraction of design information regarding one or more image components, the design extraction engine 200 can go through the at least one input file and identify and extract each image to potentially be used in one or more screens of a computer-based experience. The design extraction engine 200 of certain embodiments is configured to identify various art layers and layersets within the input file (e.g., top level layers/layersets; child layers/layersets) using the naming convention for layers or layersets to facilitate the extraction process (e.g., making the extraction more efficient). In this way, certain embodiments advantageously utilize various conventions and libraries for determining whether a layer/layerset corresponds to a text component, SVG component, image component, or a grouping of two or more such components (e.g., performed recursively), and extracting and parsing information from the art layers of the input file into appropriate files (e.g., converting a text layer to a “.txt” file, a SVG layer to a “.svg” file, an image layer to a “.png” file or a “.jpg” file, a sequence of images of an animation as a “.seq” file) and handling the conversion into json elements. For example, the design extraction engine 200 can look for every art layer that is tagged as a “.png” file and can identify this art layer as an image to be extracted from the input file to potentially be used in the computer-based experience. For each such identified and extracted image, the design extraction engine 200 can create a separate design file and can determine the dimensions (e.g., number of pixel rows; number of pixel columns; scale; opacity) and/or other characteristics of the image. Upon creating the separate design file, the design extraction engine 200 of certain embodiments transforms the image (e.g., trims the image to an optimum size) and saves the design file in a folder for later use, with the image characteristics stored as well, e.g., in JavaScript Object Notation (json) format.

For another example, for extraction of design information regarding one or more SVG components, the design extraction engine 200 can go through the at least one input file and identify and extract each SVG to potentially be used in a computer-based experience. For example, the design extraction engine 200 can look for every art layer that is tagged as a “.svg” file and can identify this art layer as an SVG to be extracted from the input file to potentially be used in the computer-based experience. For each such identified and extracted SVG, the design extraction engine 200 can create a separate design file and can determine the characteristics of the SVG (e.g., type of object; shape of object, such as rectangle, square, circle, etc.; width; height; radius; fill; stroke properties, such as color, width). Upon creating the separate design file, the design extraction engine 200 of certain embodiments saves the design file in a folder for later use, e.g., in svg file format. SVGs are advantageously used in certain embodiments since they are capable of being highly optimized and can be easily used to create graphics based on a simple file format rather than having all the details of the image saved as an image file. For example, an SVG can represent an entire image in a few lines of Extensible Markup Language (XML) code, such that the size of the XML code of the SVG is much smaller than the size of a “.png” file that would alternatively be used to represent the image. In certain embodiments, the svg file is identified and extracted by the design extraction engine 200 so as to provide optimized file sizes and computer-based experiences (e.g., game experiences).

For another example, for extraction of design information regarding one or more text components, the design extraction engine 200 can go through the at least one input file and identify and extract each text component to potentially be used in a computer-based experience. For example, the design extraction engine 200 can look for every art layer that is tagged as a “.txt” file and can identify this art layer as text to be extracted from the input file to potentially be used in the computer-based experience. While some text components will be fixed and non-customizable (e.g., included in images or SVGs), other text components that are to be customizable by the user can be extracted with appropriate characteristics. For each such identified and extracted text components, the design extraction engine 200 can create a separate design file and can determine the contents and/or other characteristics (e.g., font; width; wrapping; color; opacity) of the text component. Upon creating the separate design file, the design extraction engine 200 of certain embodiments saves the design file in a folder for later use, with the text characteristics stored as well.

In certain embodiments, the one or more files created by the design extraction engine 200 comprise at least one spritesheet comprising the images and/or the SVGs. The at least one spritesheet of certain embodiments can advantageously contain the images with minimal space wastage, resulting in a single image file and a json file with the characteristics of each frame of the computer-based experience. In certain embodiments, the design extraction engine 200 is configured to generate at least one spritesheet that includes multiple images/SVGs in an optimal manner (e.g., making the images/SVGs as small as practicable without losing any basic image data) such that the images/SVGs fit into a space as small as practicable in the spritesheet. For example, the design extraction engine 200 can be configured to determine the sizes of the images/SVGs, to trim empty spaces, to extract only the key information, and to fit the images/SVGs into the smallest space possible in the spritesheet (e.g., using a boxing algorithm configured to examine all the optimized images/SVGs, to create rows of images/SVGs in the spritesheet with a maximum number of images/SVGs correctly fit in each row, until all the images/SVGs are fit in the most optimal way), thereby taking the image/SVG data from the input file and creating a highly optimized spritesheet.

In an operational block 230, the design extraction engine 200 automatically generates computer code for a computer-based experience configured to utilize the extracted design information. In certain embodiments, the computer code is in the JavaScript programming language (e.g., configured to provide a pure html experience), while in certain other embodiments, other programming languages are used. Based on the design information received in the at least one input file, the design extraction engine 200 can determine different screens to be used in the computer-based experience and can generate appropriate computer code to create the different screens. In addition, the design extraction engine 200 can determine the positioning of each design component for these different screens and can generate appropriate computer code to position each of these design components for these different screens. For example, the computer code generated by the design extraction engine 200 can read the at least one spritesheet generated during the extraction of the design components and can determine the design components and the characteristics and transformations to be applied to each of the design components and different screens. In certain embodiments, the computer code generated by the design extraction engine 200 also includes computer code to be used by the user in customizing the computer-based experience.

For example, the design extraction engine 200 can generate an XML file which defines the computer-based experience. This experience definition file can identify the type of design component (e.g., text; image; SVG) and all the properties of each design component extracted from the input file. To generate the computer code, this experience definition file can be parsed and each design component can be created in the computer code with appropriate properties (e.g., for each text component, a text element can be created in the computer code with appropriate properties). In addition, the design extraction engine 200 can capture how the design components are grouped based on the art layers present in the input file, and the generated computer code groups all these design components so that they appear in the same form in the initial computer-based experience as they do in the input file.

In certain embodiments, the method 100 comprises creating a customized computer-based experience in the operational block 300 of FIG. 1. In some embodiments (e.g., the “custom experience creation” of FIG. 2A), the at least one input file is received from the user seeking to create the computer-based experience, and the automatically-generated computer code is used to create an initial computer-based experience used in the operational block 300. In certain such embodiments, the operational block 300 further comprises receiving user input and, in response to the received user input, modifying the initial computer-based experience to generate a customized computer-based experience.

In certain other embodiments (e.g., the “self-serve experience creation” of FIG. 2B), the operation of the design extraction engine 200 is not visible to the user seeking to create the computer-based experience, but is used to pre-generate one or more templates of computer-based experiences with pre-defined defaults. For example, the pre-defined defaults can be seeded as part of the pre-generated template, and the system can use these defaults to later generate, based on the template, the initial computer-based experience which can then be customized. In the operational block 240, the automatically-generated computer code is stored for later use as one or more templates of a computer-based experience later provided to the user for selection in creating an initial computer-based experience. For example, the user seeking to create the computer-based experience can be presented with an option to select from one or more pre-generated templates of computer-based experience with pre-defined defaults and prompted (e.g., in the operational block 300 of FIG. 1) to select from one or more of the pre-generated templates to be used in creating an initial computer-based experience. In certain such embodiments, the operational block 300 further comprises receiving user input and, in response to the received user input, modifying the initial computer-based experience to generate a customized computer-based experience.

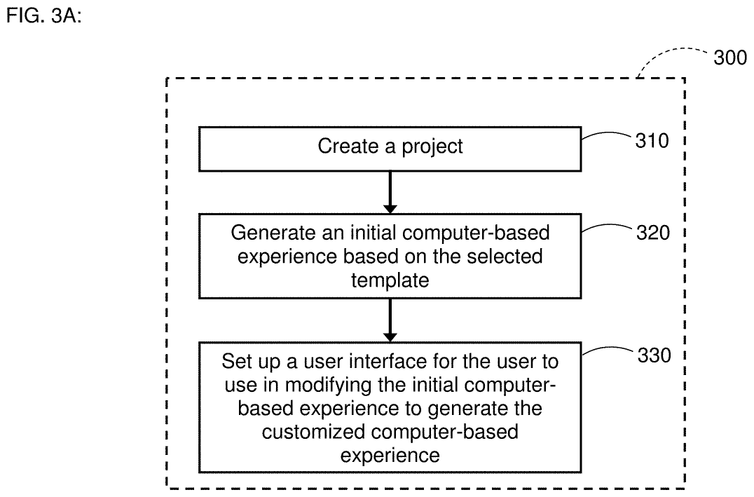

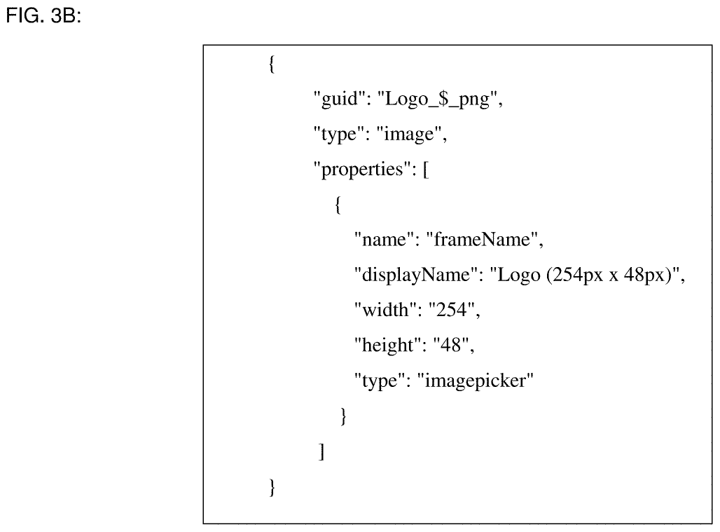

FIG. 3A is an example flow diagram of an example creation engine 300, corresponding to the operational block 300 of FIG. 1, in accordance with certain embodiments described herein. For example, the creation engine 300 can utilize one or more templates that are deployed to the cloud, and that are made accessible to the user seeking to create the computer-based experience. For example, a user interface can present a list of all the available templates to the user (e.g., with the list containing a name, description, and a preview for each available template). The user can initiate the creation engine 300 by selecting a template from the one or more templates (e.g., by using the user interface to cycle through the available templates and to signify which one of the templates is selected for use).

In an operational block 310, the creation engine 300 comprises creating a new project for the user. The project can hold the user information and the template selected by the user from the one or more pre-generated templates. The project can represent a unique instance of the computer-based experience based on a template. At a later point, the user can be prompted to provide a custom project name and description of the computer-based experience for later reference. For example, a project can include key information for the user to later recall the work done on the project, providing a shell that houses the entire computer-based experience. The user can name and describe the project appropriately so that the user can edit/view the project at a later time. The project can also include a status (e.g., published; unpublished) and if the project is published, it can also include the published URL of the project.

In an operational block 320, the creation engine 300 comprises generating an initial computer-based experience based on the selected template. For example, the creation engine 300 can access the computer code corresponding to the user-selected template and can create a copy of the user-selected template to be used as the initial computer-based experience for this user. By making a copy, certain such embodiments advantageously keep the pre-generated template separate from the initial computer-based experience, and the subsequently customized computer-based experience. The copy of the user-selected template can also include the information (e.g., pre-set defaults) and generated computer code that can be used to build the initial computer-based experience.

In an operational block 330, the creation engine 300 comprises setting up a user interface for the user to use in modifying the initial computer-based experience to generate the customized computer-based experience. For example, the creation engine 300 can create a creator-defined j son file which serves to render the user interface for each template to the user. The json file can specify the different screens to be customized and, for each screen, the design components to be customized. In addition, for each design component, the json file can specify the characteristics to be modified and the user interface elements that are shown to the user to allow the user to modify the characteristics. For example, FIG. 3B shows example code of an example json file for rendering the user interface to specify a customizable logo on a start screen of the computer-based experience, with the logo having a frame name and other characteristics (e.g., properties) in accordance with certain embodiments described herein. In certain embodiments, the entire user interface is built from the json file. For example, if the json file identifies a design component as being a certain type (e.g., text; image; SVG), the user interface will exhibit the design component as that identified type and having the identified properties. The user interface of certain embodiments comprises various functionalities to allow the user to select and modify design components of the computer-based experience and their properties (e.g., image picker, layout selector, color picker, radio buttons, checkboxes, etc.)

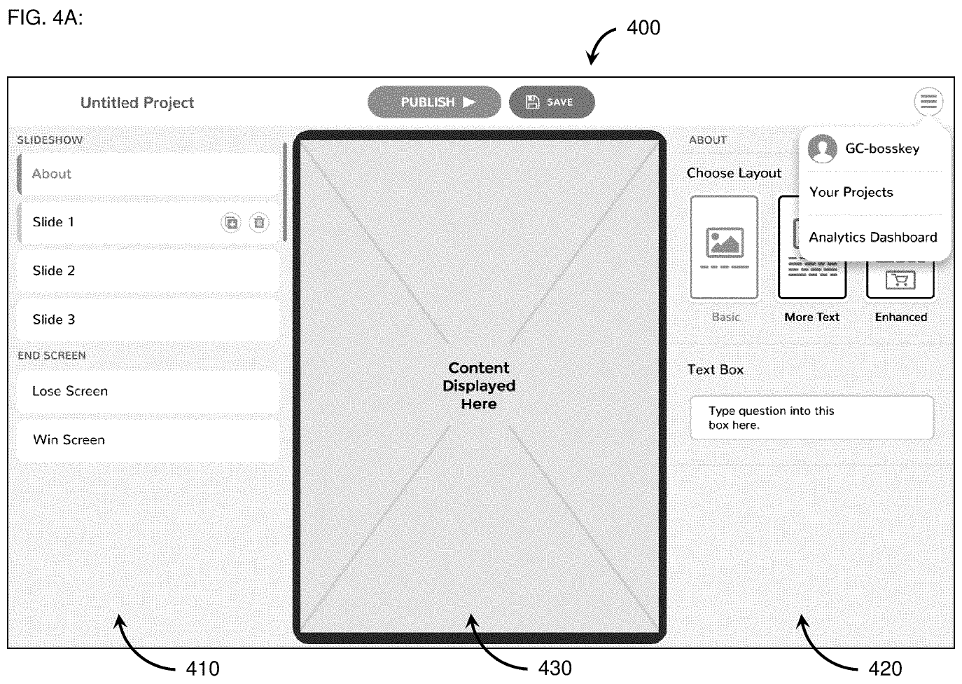

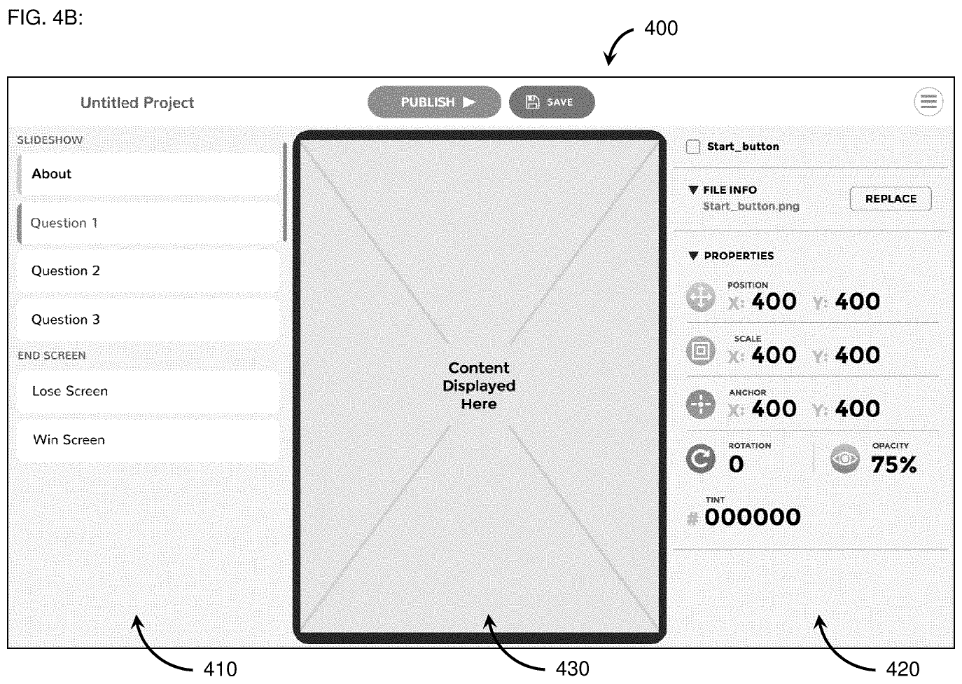

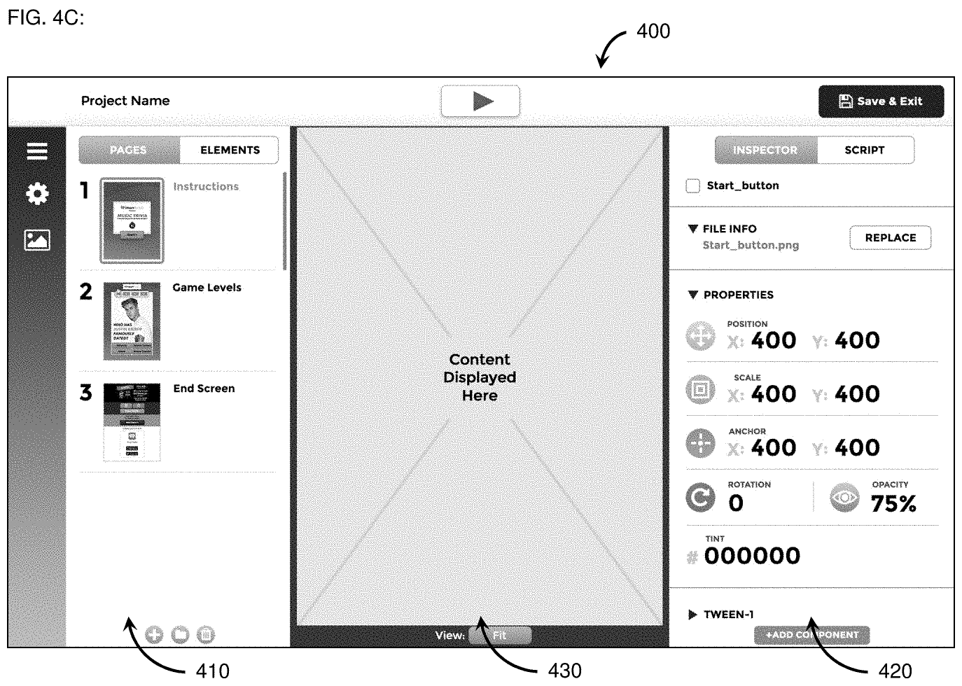

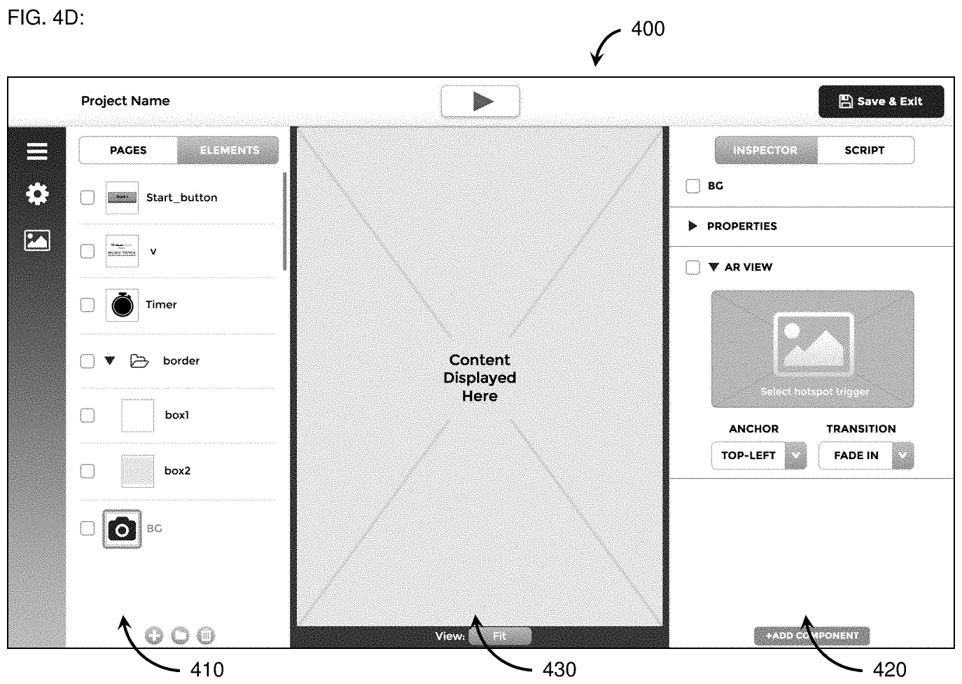

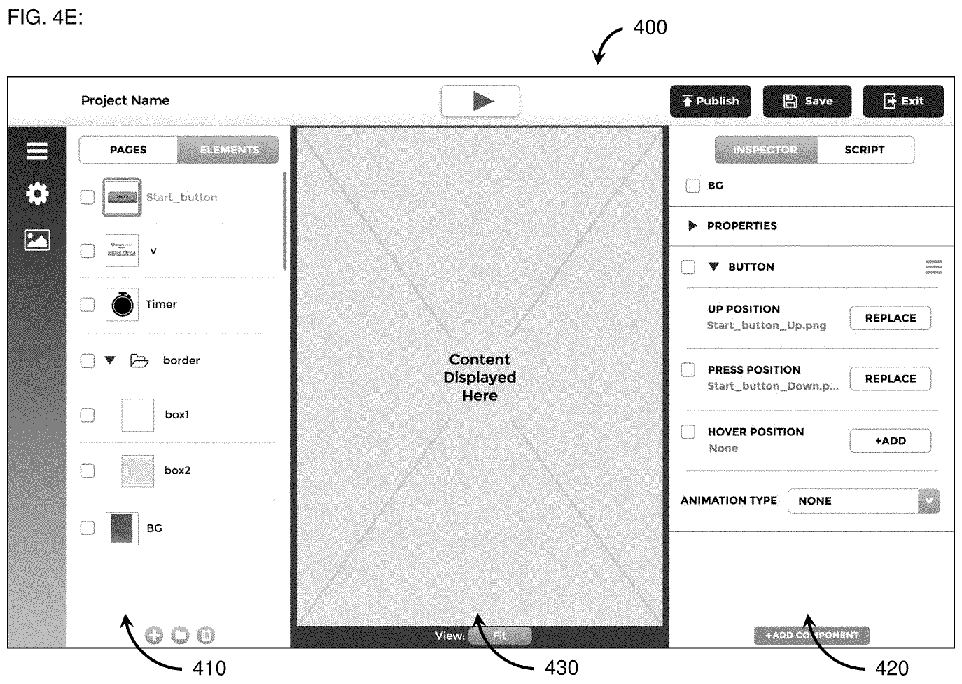

In certain embodiments, the user interface comprises one or more panels that are configured to present the user with information and options to be used in customizing the computer-based experience, from which the user can select any screen and design component and can customize the computer-based experience to the needs of the user. FIGS. 4A-4E show example views of an example user interface 400 for modifying a computer-based experience in accordance with certain embodiments described herein. The user interface 400 comprises a first panel 410 configured to show the user each of the screens (e.g., groups of design components) of the computer-based experience that can be selected by the user to be modified (e.g., each of the screens of a template that are capable of being modified). These groups of design components can be repeating groups (e.g., occurring multiple times within the computer-based experience), and the groups can be added, deleted, or modified. The user interface 400 further comprises a second panel 420 configured to show the design components of the selected screen and the characteristics of the design components that can be selected by the user to be modified. The second panel 420 can be further configured to show custom content to the user to be used to customize (e.g., personalize) the computer-based experience.

For example, as shown in FIG. 4A, the first panel 410 of the user interface 400 lists a plurality of screens of the computer-based experience (e.g., slideshow) that can be selected by the user to be modified, added, or deleted. The screens listed on the first panel 410 of FIG. 4A include an “About” screen, a “Slide 1” screen, a “Slide 2” screen, a “Slide 3” screen, and two alternative end screens: a “Lose Screen” and a “Win Screen.” During the computer-based experience, one or the other of the two alternative end screens can be presented depending on a conditional event (e.g., for a computer-based trivia game, if a winning score is achieved by the individual then the “Win Screen” is presented, and if a non-winning or losing score is achieved by the individual then the “Lose Screen” is presented). These alternative end screens can each be configured by the user via the user interface 400. In FIG. 4A, the “About” screen is selected by the user to be modified, and the second panel 420 of the user interface 400 shows different layouts that can be selected by the user for the “About” screen and a text box for the user to enter text to be used on the “About” screen. FIG. 4A also shows a dropdown menu overlaid onto the second panel 420, showing the user name, a field (“Your Projects”) for selecting the project to be edited, and a field (“Analytics Dashboard”) for accessing analytics information regarding the computer-based experience.

For another example, as shown in FIG. 4B, the first panel 410 has the “Slide 1,” “Slide 2,” and “Slide 3” screens renamed as “Question 1,” “Question 2,” and “Question 3,” respectively, with the “Question 1” screen selected by the user for modification. The second panel 420 of FIG. 4B shows a checkbox corresponding to the inclusion of a “start_button” design component on the “Question 1” screen and its characteristics that can be selected and modified by the user, including file information regarding the file containing the “start_button” to be used (e.g., “Start_button.png”), and various characteristics (e.g., “properties”) for the “start_button” (e.g., position, scale, anchor, rotation, opacity, and tint).

For another example, as shown in FIG. 4C, the first panel 410 includes buttons to toggle between a list of “pages” and a list of “elements,” with the “pages” button selected by the user and listing three pages: “Instructions,” “Game Levels,” and “End Screen.” The second panel 420 of FIG. 4C shows a checkbox corresponding to the inclusion of a “start_button” design component on the “Instructions” page and its characteristics that can be selected and modified by the user, including file information regarding the file containing the “start_button” to be used (e.g., “Start_button.png”), and various characteristics (e.g., “properties”) for the “start_button” (e.g., position, scale, anchor, rotation, opacity, and tint). In addition, the second panel 420 of FIG. 4C includes buttons to toggle between an “inspector” view and a “script” view, another design component (e.g., “Tween-1”), and a button to initiate addition of another design component. For example, using the “inspector” view, the user can specify the properties of the object/screen that is being customized, whether for “custom experience creation” or “self-serve experience creation.” For “custom experience creation,” since the experience logic is not predetermined, the user can use the “script” view to provide additional javascript to modify the experience logic.

For another example, as shown in FIGS. 4D and 4E, the first panel 410 includes buttons to toggle between a list of “pages” and a list of “elements,” with the “elements” button selected by the user and listing five elements: “Start_button,” “v” (e.g., a logo image), “Timer,” “border” (with two alternatives: “box1” “box2”), and “BG” (e.g., background), each having a checkbox for selecting the corresponding element. The second panel 420 of FIGS. 4D and 4E shows a checkbox for “BG” (e.g., background) along with an expandable field “Properties.” The second panel 420 of FIG. 4D also shows a field “AR View” for modifying characteristics (e.g., anchor; transition) of an AR design component. The second panel 420 of FIG. 4E shows a checkbox for “BG” (e.g., background) along with an expandable field “Properties” and a field “Button” for modifying characteristics (e.g., up position; press position; hover position; animation type) of a button design component. The “Animation Type” can be used to specify the type of animation to be used (e.g., ease in; fade in; bounce in; etc.). In addition, the second panel 420 of FIGS. 4D and 4E includes buttons to toggle between an “inspector” view and a “script” view, and a button to initiate addition of another design component.

The user interface 400 further comprises a third panel 430 configured to show an “instant” (e.g., immediate) preview of the changes made to the computer-based experience for the selected screen (e.g., in a region labeled “Content Displayed Here” in FIGS. 4A-4E). For example, the user can provide user input to the creation engine 300, the user input indicative of a change to be made to a characteristic (e.g., property) of a design component element, and the creator engine 300 can receive the user input and can determine which design component is being modified and which screen the modified design component belongs to. In the examples shown in FIGS. 4A and 4B, the third panel 430 includes buttons to allow the user to select to “Publish” and/or “Save” the modified computer-based experience. In the examples shown in FIGS. 4C-4E, the third panel 430 includes a button to initiate the “instant” (e.g., immediate) review of the computer-based experience, and a “View: Fit” button to select how the preview is viewed within the region (e.g., to adjust the preview of the experience to fit exactly on the screen).

The third panel 430 can access an “experience engine” which is configured to receive input from the creation engine 300 and to exhibit a version of the selected screen that includes the change to be made and/or the entire computer-based experience in a predetermined region of the user interface 400. The experience engine of certain embodiments comprises a composition of all the computer code, spritesheets, and other files and assets that define the design components of the computer-based experience. Besides being configured to exhibit the “instant” preview in the user interface 400, the experience engine is configured to render the entire published computer-based experience. For example, the creation engine 300 can raise an event with the information regarding the modified design component to the experience engine (e.g., which is constantly listening for events from the creator engine). The experience engine can then switch to the appropriate screen in the computer-based experience and can apply all the modifications based on the user input provided by the user.

As mentioned with regard to the design extraction engine, the code for the experience engine of certain embodiments is built in a way to support customizations easily. For example, for the design extraction engine 200, all the design components and their characteristics can be extracted as a json XML file, which can be overwritten either in parts or completely by a similar json XML file generated by the user interface and is configured to be read per computer-based experience and applied automatically by the automatically generated computer code. Certain such embodiments provide an easy customization of the computer-based experience, since this json XML file generated by the user interface can be used by the experience engine. The user interface 400 can then refresh to show the newly applied changes to the computer-based experience, thereby providing an “instant” preview of each change that is made. As changes are continually made, the user can advantageously see them as they are rendered, rather than waiting until they are published. In certain embodiments, the user interface 400 presents different previews and/or functionalities depending on the skill of the user. For example, for the “self-serve experience creation” of FIG. 2B, only selected fields are capable of being customized by the user, thereby making the modification easy even for a user that is not familiar with design or code, and keeping the end results of computer-based experiences consistent with one another. For another example, for the “custom experience creation” of FIG. 2A, all the design components can be made available to the user to modify, thereby providing the user (e.g., having some knowledge of design as well as code) with full control for defining the entire computer-based experience.

In certain embodiments, the user interface is configured to allow the user to use the creation engine 300 to modify one or more components of the computer-based experience, including but not limited to: image components, scalable vector graphic (SVG) components, text components, tween components, animation components, physics components, and camera and augmented reality (AR) components. For each of these example component modifications, the computer code generated by the creation engine 300 can access the modified objects and files to render the computer-based experience appropriately.

For example, the user can modify and save image components, SVG components, and/or text components, with the characteristics (e.g., properties) of the components in a design file (e.g., in json format). For another example, the user can dynamically control or modify tween components that perform various functions and provide additional dynamic mechanisms of the computer-based experience (e.g., dynamic transitions from one screen to another, such as in a sideways motion; dynamically bouncing a button into place, etc.). The creation engine 300 can generate a timeline with the tween transitions stored as a j son object which specifies the entire timeline, with the experience engine configured to dynamically handle the timeline json object and the tweens when rendering the computer-based experience.

For another example, the user can control or modify a series of images or frames for animation (e.g., a series of images showing stages of a central character running in a game), and the creation engine 300 can access the frames and generate an animation spritesheet and a corresponding json file. For another example, the user can control or modify the physics properties (e.g., motion, collisions, gravity or other forces, etc.) of objects moving or interacting with one another within the computer-based experience (e.g., balls colliding with a floor or one another; bullets being shot by a spaceship onto targets or enemies), with the creation engine 300 generating computer code to handle the physics appropriately.

For another example, the user can control or modify operation of a camera of the individual's computing device (e.g., smartphone) being used during the computer-based experience and one or more AR components of the computer-based experience. The user can control or modify requests for access to the camera on the individual's computing device, how the camera output is to be used (e.g., as a canvas generated in the background over which the AR components are presented), etc. For example, the camera output can be projected onto a canvas, and the AR components and the html experience can be superimposed onto the canvas. Certain such embodiments advantageously create an AR experience using purely html technologies without utilizing any app download and without relying on any OS features. By using the creation engine 300 to build an exciting html experience, and overlaying it on actual camera feeds using the AR component, certain embodiments advantageously allow the user to build a truly dynamic AR experience, which will work reliably regardless of the platform upon which the computer-based experience is deployed.

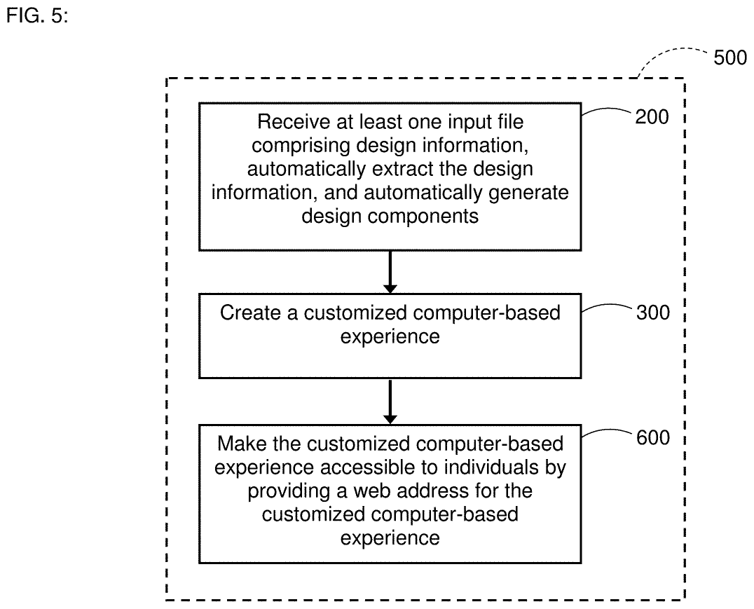

Once the computer-based experience is created, certain embodiments described herein disseminate (e.g., publish) the computer-based experience to be accessed by individuals using their computing devices. For example, once the user has performed all the desired personalizations and customizations of the screens of the computer-based experience using the creation engine 300, the user can publish the computer-based experience. FIG. 5 is a flow diagram of an example method 500 for creating and disseminating a computer-based experience in accordance with certain embodiments described herein. The method 500 comprises the operational blocks 200 and 300 as described herein. In an operational block 600 (e.g., using a publish engine), the method 500 further comprises making the customized computer-based experience accessible to individuals using their computing devices by providing a web address for the customized computer-based experience.

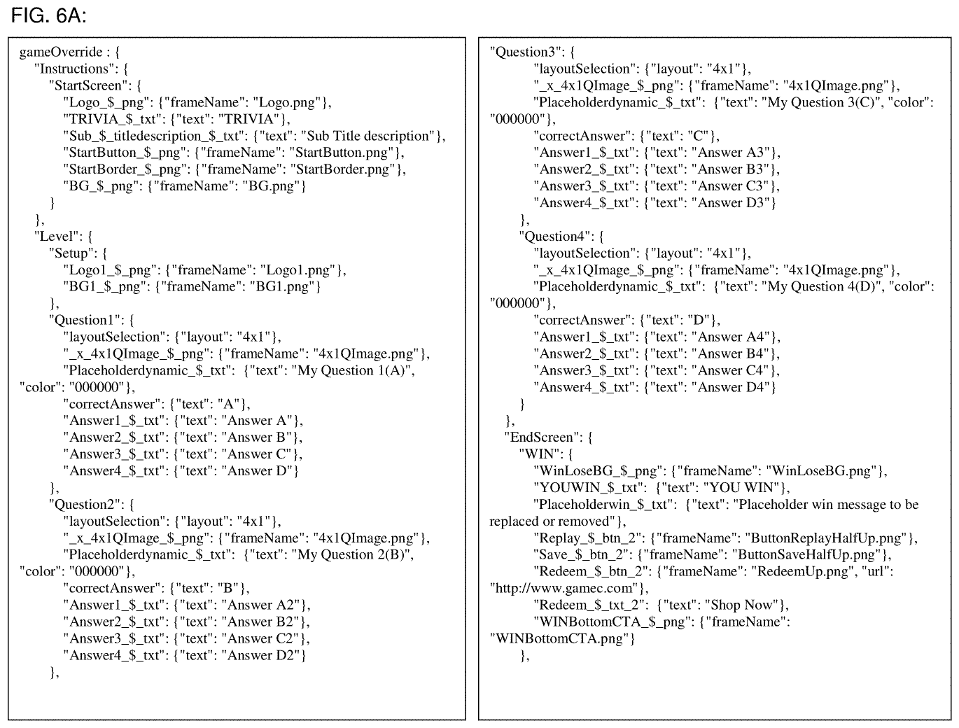

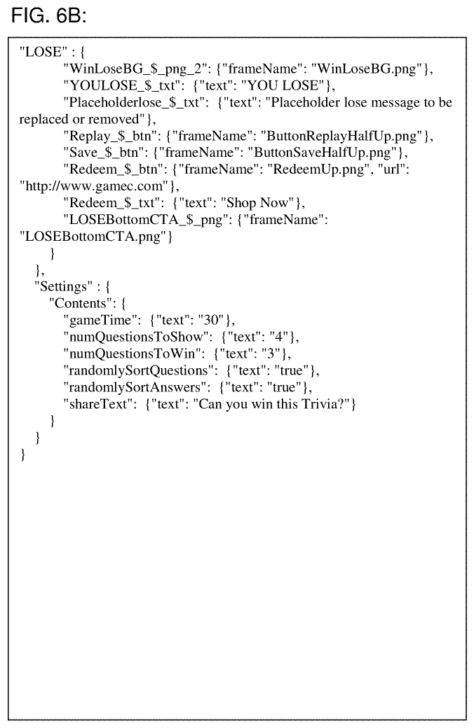

FIGS. 6A-6B show example computer code for a published trivia game in accordance with certain embodiments described herein. In certain embodiments (e.g., in the example of FIGS. 6A-6B), the publish engine 600 constructs computer code comprising an override object based on the user-modified properties and customization of the computer-based experience, which is configured to be accepted by the experience engine of the creation engine. When the computer-based experience is run by the individual, the experience engine applies this override object to all the screens to render the computer-based experience desired by the user to be published. In addition, in certain embodiments, the publish engine takes any media provided by the user (e.g., custom images) and replaces the default images of the template with the corresponding custom images, and creates a spritesheet from these images which is used in place of the default image spritesheet. In certain embodiments, the publish engine also compresses and optimizes the spritesheets to facilitate the computer-based experience operating in an optimal manner. All the files, the computer code, the replaced assets, the spritesheets, etc. can then be deployed to a content delivery network (CDN), thereby enabling effective caching and rendering of the computer-based experience.

In certain embodiments, the user is provided a URL for disseminating the computer-based experience so that individuals can access the published computer-based experience. This URL can represent the entire computer-based experience and all the computer code can be built entirely using html/javascript and can work on any browser. The computer-based experience of certain embodiments does not require any app or plugins to be used or downloaded, thereby enabling the user to use the same URL in a variety of ways, examples of which include but are not limited to one or more of the following: embedding the URL in the user's website to create a microsite experience; using the URL in a mobile ad campaign to enable computer-based experiences on individuals' mobile devices; sharing the url via email; creating QR codes or snap codes that can launch the computer-based experience when scanned.

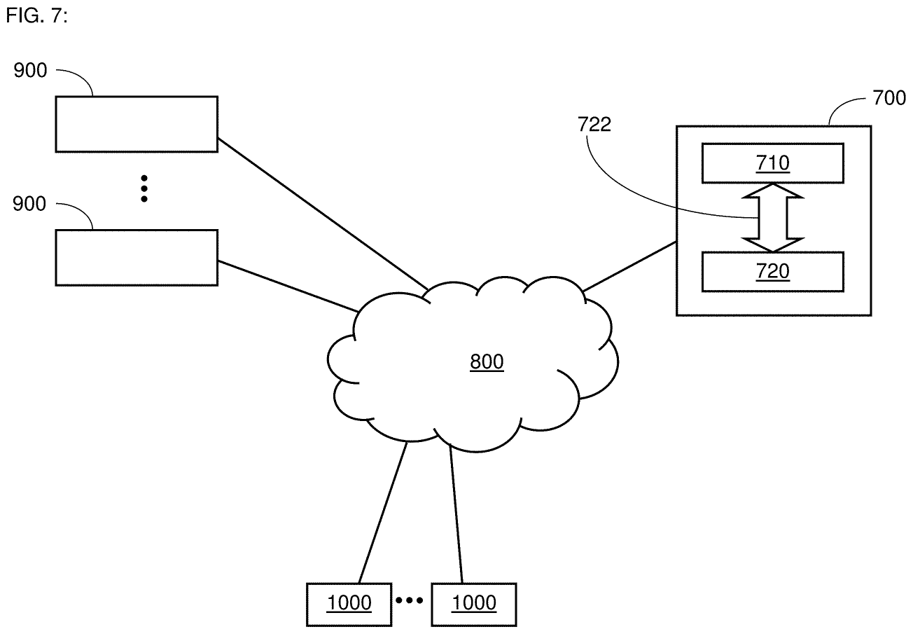

FIG. 7 schematically illustrates an example computer system 700 for creating a computer-based experience in accordance with certain embodiments described herein. The computer system 700 comprises at least one processor 710 in operative communication with one or more user computing devices 900 via the internet 800 and in operative communication with one or more individual computing devices 1000 via the internet 800 configured to access the computer-based experience via the internet 800. The one or more user computing devices 900 are configured to provide user input to the at least one processor 710 while creating and/or modifying the computer-based experience. The computer system 700 further comprises at least one memory device 720 that is in operative communication with the at least one processor 710. The at least one memory device 720 is operative to store information 722 (e.g., instructions; data) to be used by the at least one processor 710 and/or generated by the at least one processor 710, and to provide the stored information 722 to the at least one processor 710. For example, the at least one memory device 720 can store information 722 that is configured to instruct the at least one processor 710 to perform the method 100, to operate as the design extraction engine 200, to operate as the creation engine 300, and/or to perform the method 500. The computer system 700 is in operative communication, via the internet 800, with one or more computing devices 900 of users seeking to use the computer system 700 to create a computer-based experience that is accessible to individuals' computing devices 1000 via the internet 800 in accordance with certain embodiments described herein.

### Example Game Generation

In an example process, a detailed file format specification for the input design file is selected for use or a language is selected that the design API supports. For example, for Adobe Photoshop® input files, Action Script or Javascript can be used, and for Gimp, Python or Script-Fu can be used. The design canvas can be resized (e.g., if the designers have worked using higher resolutions, resizing can be performed to make the sprite sheets smaller). The API can be used to perform various steps for automatically extracting the design information and automatically generating design components:
Trim the layers or layer sets to provide the dimensions to be used.
Extract the detailed information (e.g., position, size, name, corresponding image, text, transparency, rotation, scale, or any other property that may be useful for generating the experience).
   For layers with “.svg” suffix, the layer can be evaluated to determine whether the layer can be represented as SVG. If so, the layer is transformed to SVG and extract the SVG definition.
   For text elements (e.g., layers that have a name ending with a “.txt” suffix), extract the detailed information (e.g., font, font size, alignment, word wrapping, font weight, etc.).
      Text definitions can be extracted for dynamic use (e.g., to present a user's score which is not constant and changes during the experience).
   For image layers (e.g., layers that have a name ending with a “.png” or “.jpg” suffix), save the layer as an image.
   For animation layer sets, extract the individual images in the animation sequence (e.g., a set of 30 running frames of a running figure).
For each image:
   Trim the image to reduce the size of the layer (e.g., can include scaling the image as well).
   SVGs can be used, but they may cause a slow down (e.g., when rendering a 60 frames per second) due to the processor switching sprite sheets.
   Large images can be broken into smaller rectangular images. The large image can be evaluated to determine whether one small rectangular image can be sufficient to represent the whole larger image, and if so, the small rectangular image can be saved and used.
      For example, a background image that is 1000×1000 pixels and is substantially uniform can be represented instead by a small tile (e.g., 100×100 pixels) that is painted as 100 tiles of 10 by 10. The size of the tile can be optimized relative to the expected performance of the graphics renderer to be used.
For sprite generation, after extracting the game definition (e.g., the information from the input design file), all the extracted images (e.g., tens to hundreds of images from a single input design file) are packed into a smaller number of sprite sheets (e.g., less than 10 sprite sheets; less than 5 sprite sheets; less than 3 sprite sheets; a single sprite sheet).
   The order of the elements in the input design file can be preserved such that the order in which the elements are painted (e.g., rendered on the screen) so that the final experience (e.g., game) conforms to what the designer intended.
   The same element can be used in multiple places in a screen.
      For example, a single tree image can be extracted, and the same tree image can be used multiple times and in multiple places in a park scene. These different instances of the same tree can have different parameters (e.g., size scale, rotation, transparency) to produce trees looking different from one another.
   While packing the extracted images, the images related to the same animation are placed in the same sprite sheet (e.g., to make game rendering more efficient by avoiding having the sprite sheet to be swapped out during the game rendering).
All the SVG images are also stitched into the sprite sheets as well.
   Extract the width and height of the SVG image.
   Use a boxing algorithm for all the SVG images to determine an order for placing them in SVG.
   Place each SVG image in a <defs> element.
   With a <g> element tag, the predefined image having the <defs> tag can be used.
   The sprite sheet will have all of the individual SVG images (e.g., generate the corresponding json file to indicate where each individual image is positioned).
   This SVG can be loaded in a html document using <img> tag.

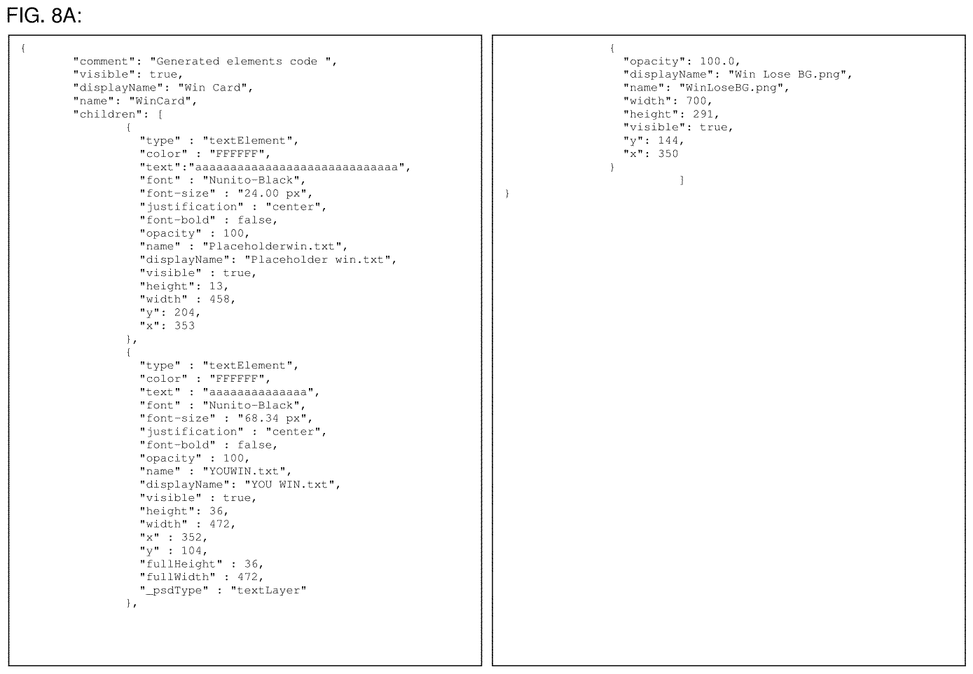

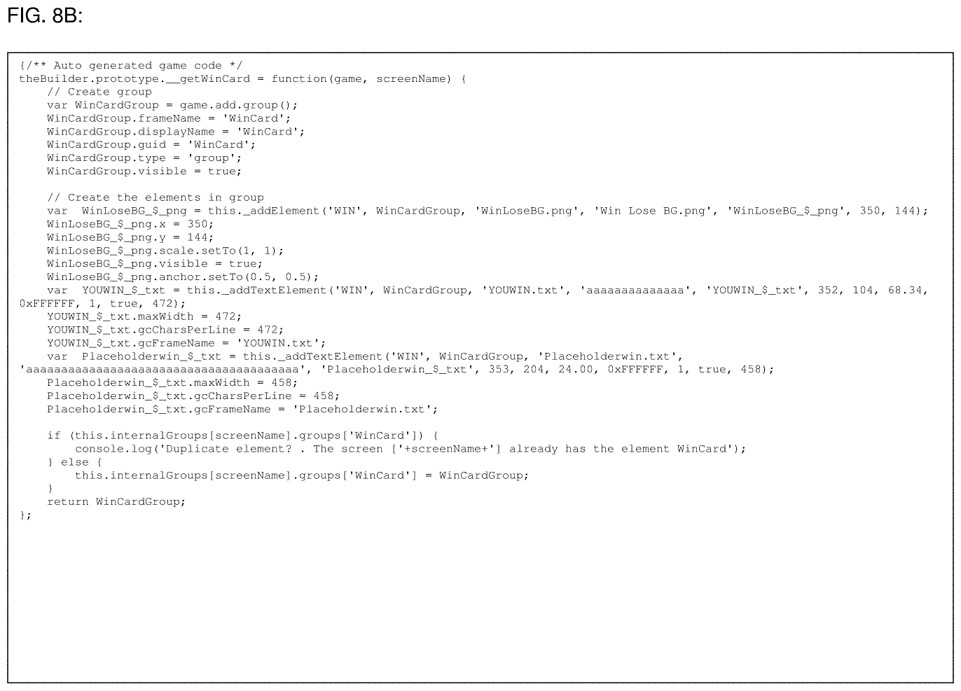

Once the images and related information are extracted from the input file, the sprite sheets can be built automatically, and the extracted game definition can be used to generate the game code (e.g., builder code). FIG. 8A shows an example of game code corresponding to two text elements and an image element extracted from a Photoshop document in accordance with certain embodiments described herein. FIG. 8B shows an example of the automatically generated game code in accordance with certain embodiments described herein. The generated game code can then be used for rendering the game.

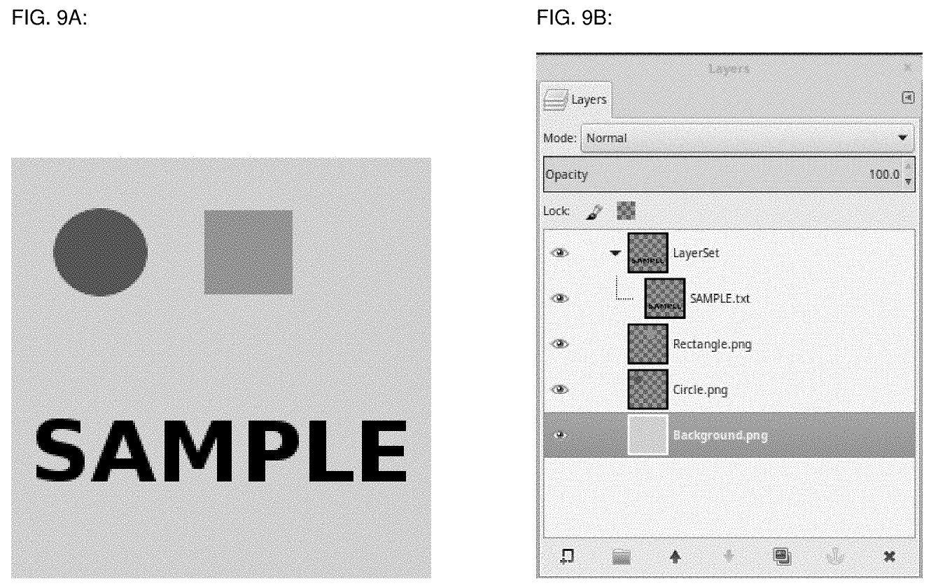

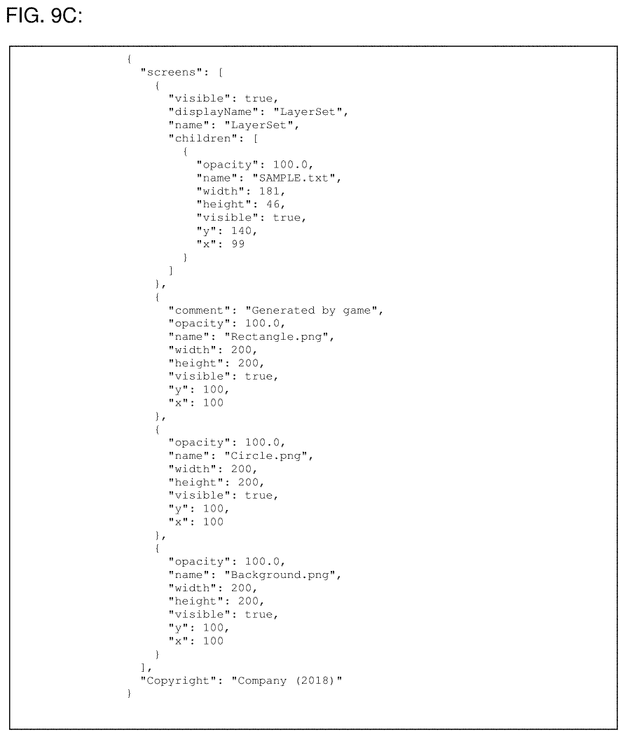

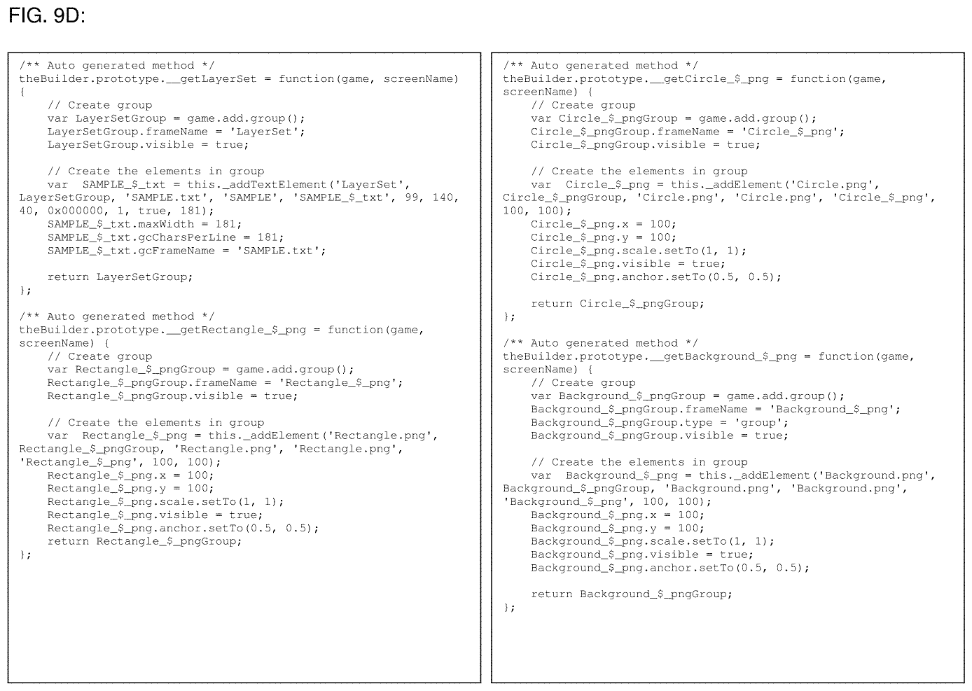

For another example, the game definition (e.g., previously extracted in json format) can be used to generate code using parsers. For example, a json parser can be used to iterate through each element and to construct the json object corresponding to the element from the data extracted from an input design file (e.g., using a template to render the element, such as rendering an image element at a position specified by the j son element information). FIG. 9A shows an example screen, FIG. 9B shows example layers of the example screen of FIG. 9A, and FIG. 9C shows example code automatically generated for the example screen of FIG. 9A and the example layers of FIG. 9B in accordance with certain embodiments described herein. In addition, the images Rectangle.png, Circle.png, and Background.png are generated. FIG. 9D shows example game code (e.g., builder code) automatically generated for the screen of FIG. 9A.

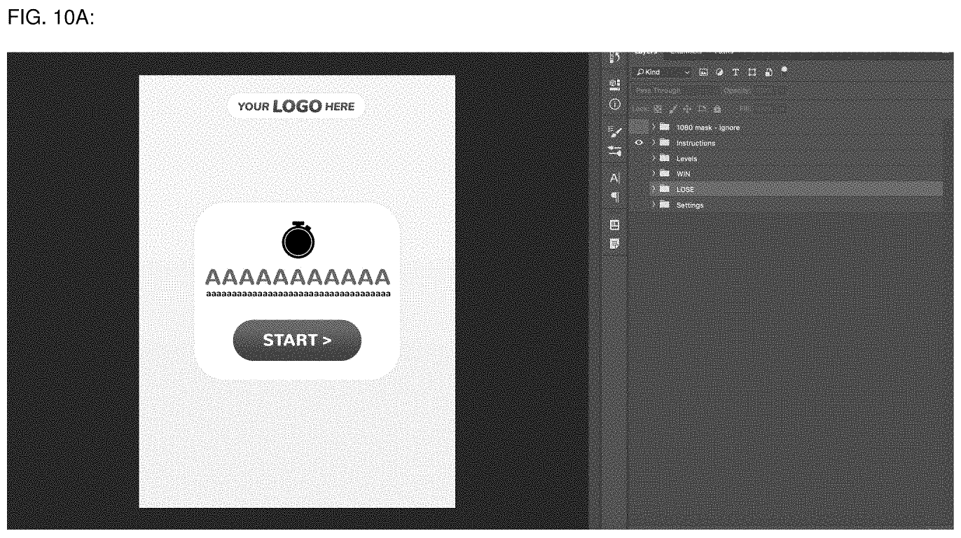

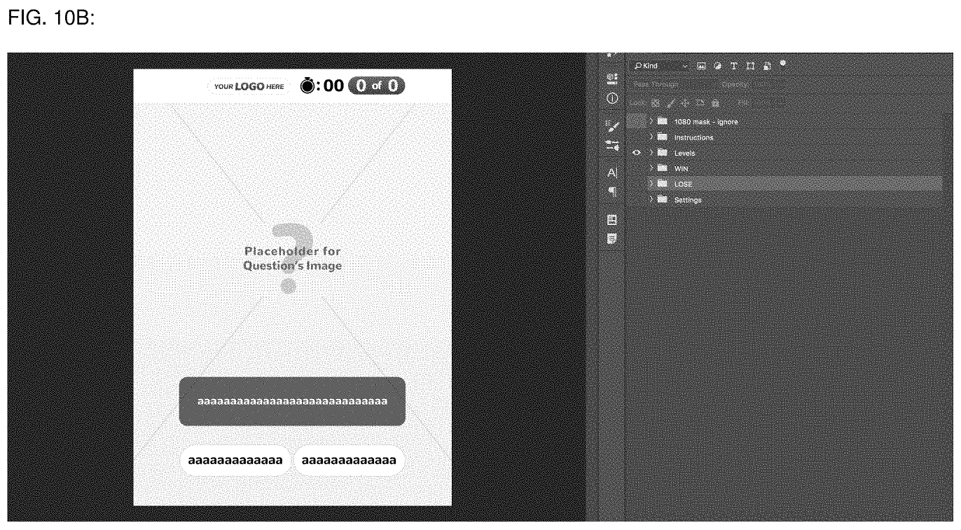

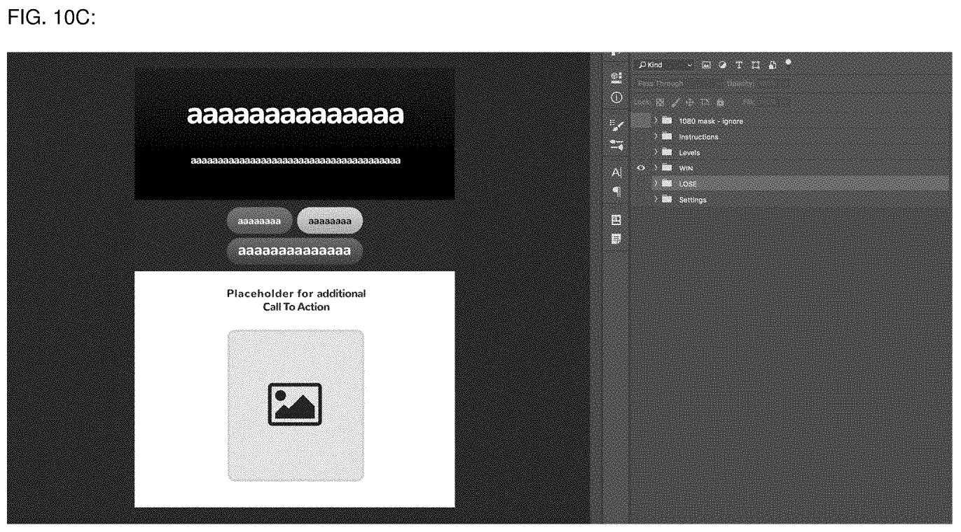

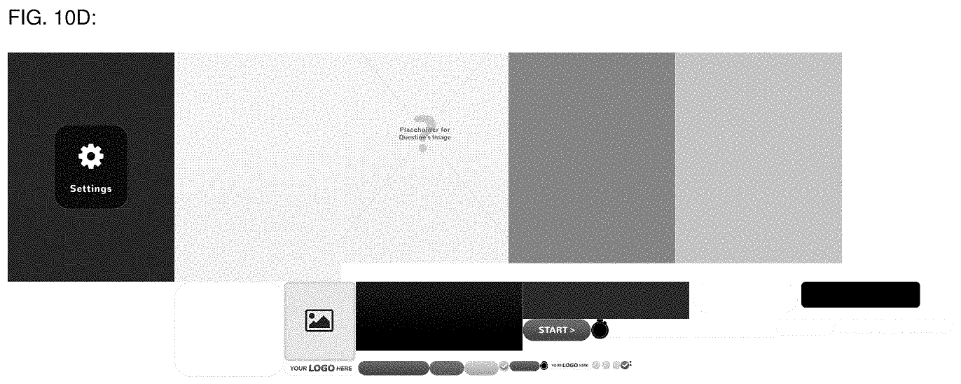

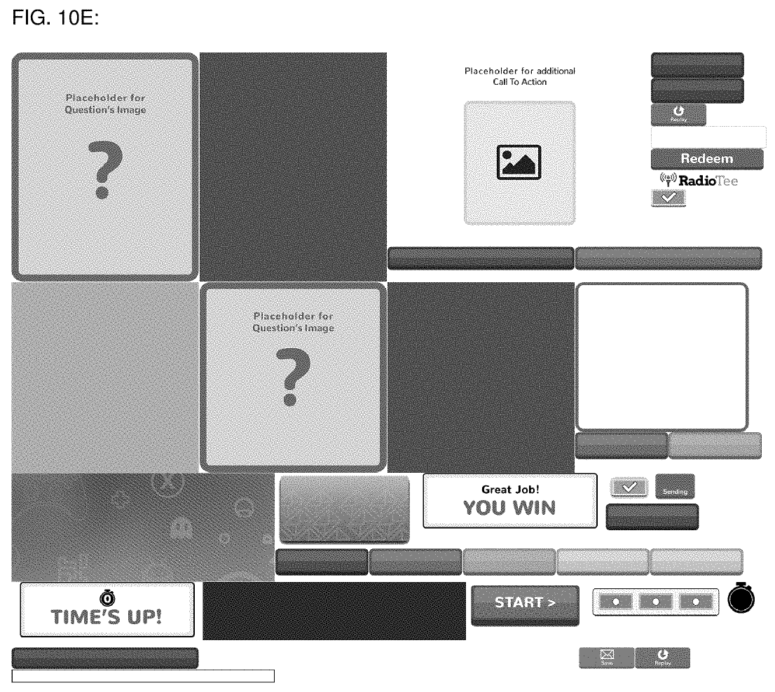

FIGS. 10A-10E illustrate example screenshots of images for an example method of creating a customized computer-based experience in accordance with certain embodiments described herein. While the example method of FIGS. 10A-10E utilizes a template design, other methods utilize a design uploaded by the user, in accordance with certain embodiments described herein, and allow further customization of the design.

FIGS. 10A-10C show screenshots of example pages of a template design file for a trivia game. The template design file includes game logic code and can be provided to the user (e.g., by the creation engine 300). FIG. 10A shows an example first page of the trivia game template, FIG. 10B shows an example question page of the trivia game template, and FIG. 10C shows example win/lose pages of the trivia game template. Each of these example pages can be a layer for the design in an input file (e.g., a photoshop file) received by the design extraction engine 200. The design extraction engine 200 can extract the json game definition file (e.g., game_def.json) as well as the spritesheet json files (e.g., sprite_0.json; sprite_1.json) and png files (e.g., sprite_0.png; sprite_1.png) for the assets of these pages from the input file. FIGS. 10D and 10E show example spritesheet png files of the trivia game template. These files can then be provided to the creation engine 300, as described herein, and can be available as a “trivia template” for selection by the user for customization.

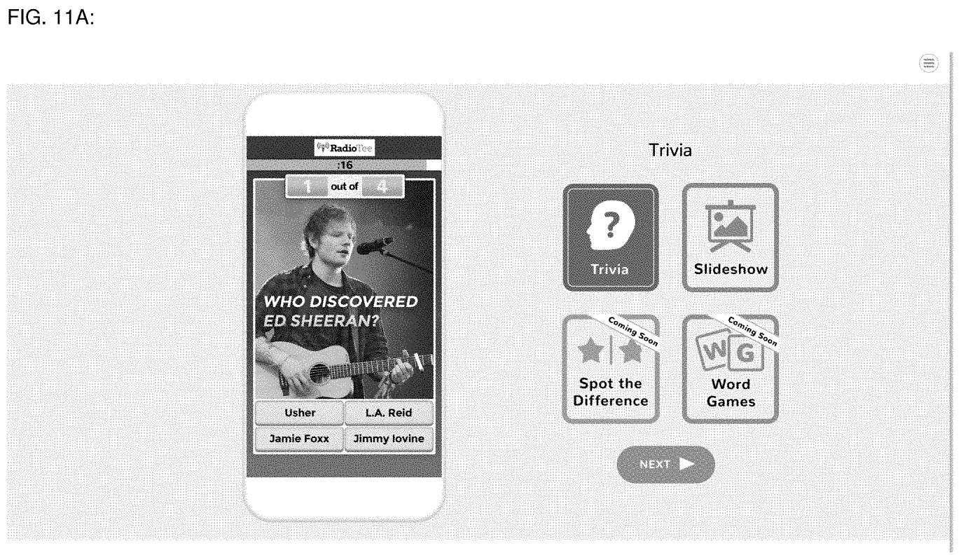

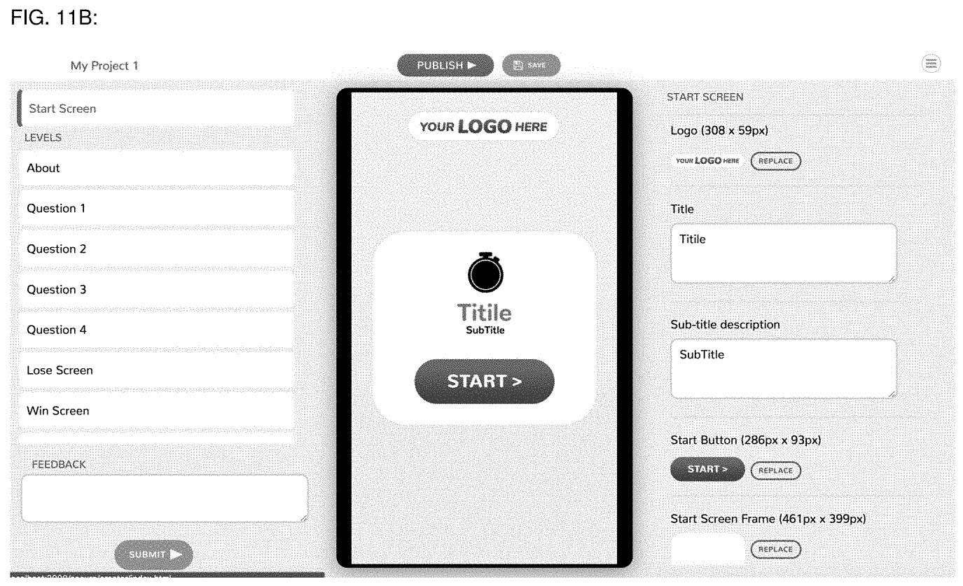

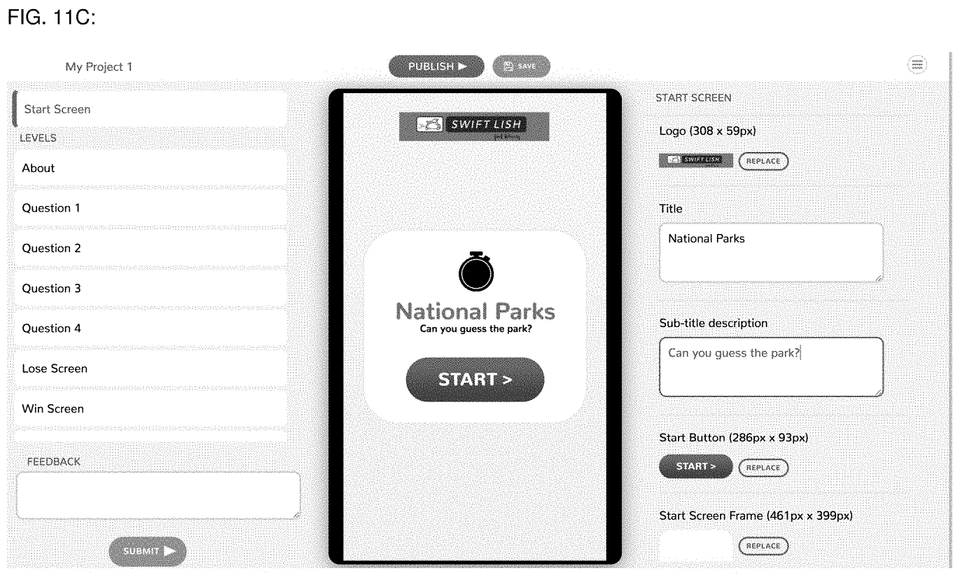

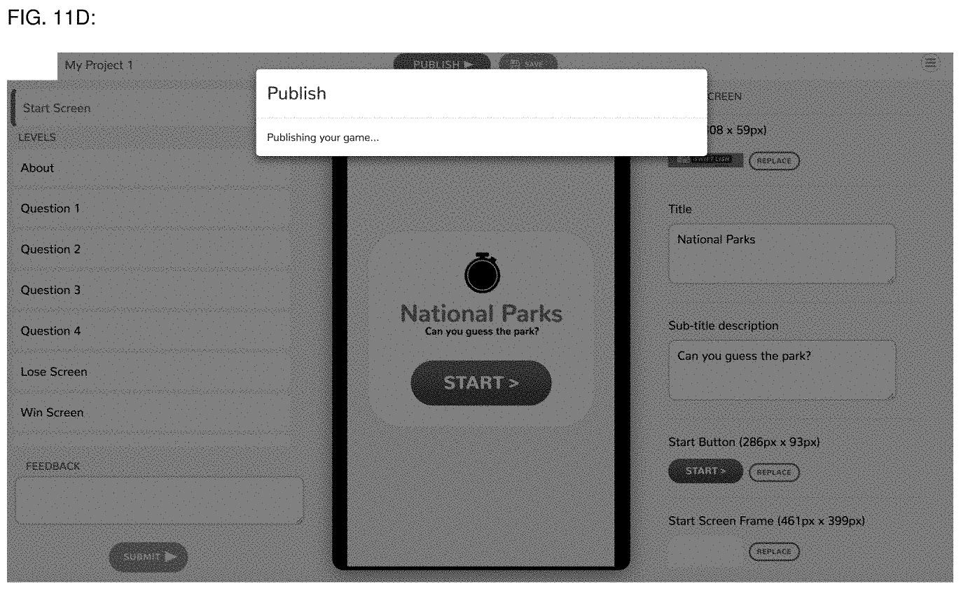

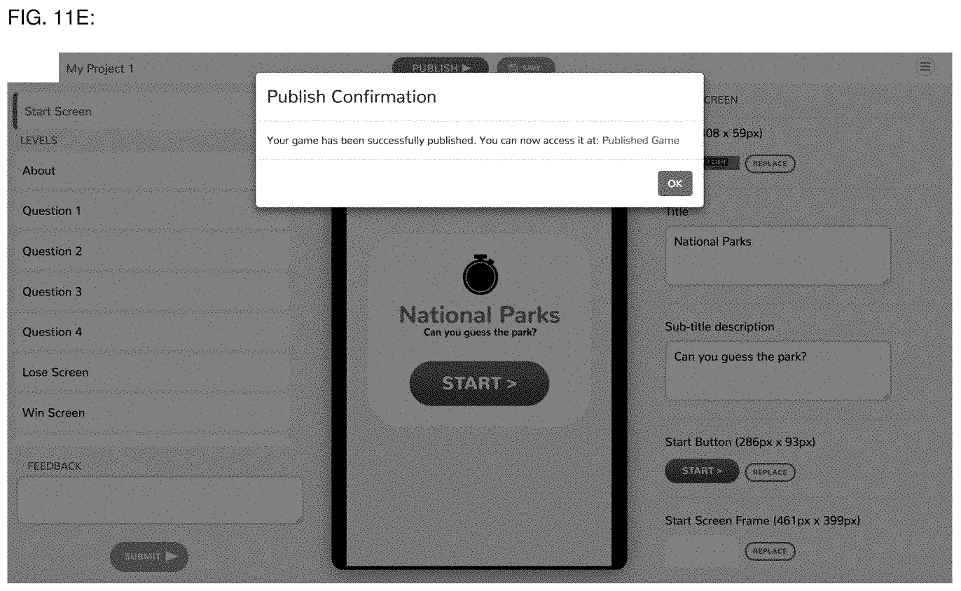

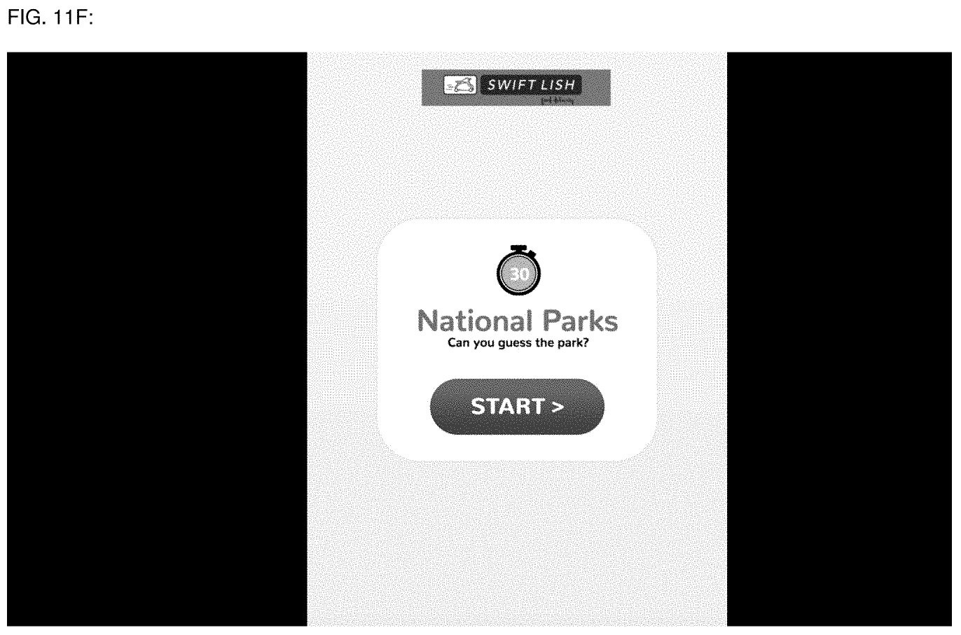

FIGS. 11A-11F illustrate screenshots of example pages presented to the user in a web browser for creating a customized computer-based experience in accordance with certain embodiments described herein. FIG. 11A shows a screenshot of an example page having a right side from which the user can select a template design to use from among four options, with other options available by clicking a “next” button. The left side of the screenshot of FIG. 11A shows an example image corresponding to the highlighted template design option. Once the user selects a template design (e.g., “Trivia”), the corresponding template design files are used to create a project by which the user can customize the computer-based experience.

FIG. 11B shows a screenshot of an example customization page. This example customization page shows the customizable groups of the template (e.g., “Start Screen,” “About,” “Question 1,” etc.) on the left side, a preview of the customized game in the center, and the customizable elements and their properties (e.g., “Logo,” “Title,” etc.) for the selected group (e.g., “Start Screen”) on the right side. On this page, the user is able to make customizations, such as replacing images, changing text, etc. to make the experience suitable to the user's needs. FIG. 11C shows a screenshot of an example customization page after the user has made some customizations (e.g., replacing the logo image and changing the title and sub-title). The user can leave some elements unchanged and utilizing the default settings (e.g., utilizing the default “Start Button”). The user can continue the customization as appropriate for all the groups of the template.

Once the user is done making customization changes, the user can click the “Publish” button (e.g., at the top center of the customization page) to begin the building of the customized computer-based experience and then publishing the experience (e.g., providing a web address for the customized computer-based experience). FIG. 11D shows a screenshot of an example of the page presented to the user indicating that the publication is in process, and FIG. 11E shows a screenshot of an example of the page presented to the user indicating that the publication has been successfully completed and providing a link (e.g., “Published Game”) for directly accessing the customized computer-based experience in the browser. FIG. 11F shows a screenshot of an example browser page presented to the user upon clicking the publication link (e.g., a URL link).

Certain embodiments described herein include methods which are performed by computer hardware, software or both, comprising one or more modules or engines (e.g., hardware or software programs that perform a specified function; can be used in operating systems, subsystems, application programs, or by other modules or engines). The hardware used for certain embodiments described herein can take a wide variety of forms, including processors, network servers, workstations, personal computers, mainframe computers and the like. The hardware running the software will typically include one or more input devices, such as a mouse, trackball, touchpad, and/or keyboard, a display, and computer-readable memory media, such as one or more random-access memory (RAM) integrated circuits and data storage devices (e.g., tangible storage, non-transitory storage, flash memory, hard-disk drive). It will be appreciated that one or more portions, or all of the software code may be remote from the user and, for example, resident on a network resource, such as a LAN server, Internet server, network storage device, etc. The software code which configures the hardware to perform in accordance with certain embodiments described herein can be downloaded from a network server which is part of a local-area network or a wide-area network (such as the internet) or can be provided on a tangible (e.g., non-transitory) computer-readable medium, such as a CD-ROM or a flash drive. Various computer languages, architectures, and configurations can be used to practice the various embodiments described herein. For example, one or more modules or engines can be provided by one or more processors of one or more computers executing (e.g., running) computer code (e.g., one or more sets of instructions which are executable by the one or more processors of one or more computers). The computer code can be stored on at least one storage medium accessible by the one or more processors, as can other information (e.g., data) accessed and used by the one or more processors while executing the computer code.

Any process descriptions, elements, or blocks in the flow diagrams described herein and/or depicted in the attached figures should be understood as potentially representing modules, engines, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer readable storing the computer executable components such as a CD-ROM, DVD-ROM, or network interface further, the component and/or data can be included in a single device or distributed in any manner. Accordingly, computing devices may be configured to implement the processes, algorithms and methodology of the present disclosure with the processing and/or execution of the various data and/or components described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although commonly used terms are used to describe the systems and methods of certain embodiments for ease of understanding, these terms are used herein to have their broadest reasonable interpretation, as described in more detail herein. Although various aspects of the disclosure are described with regard to illustrative examples and embodiments, one skilled in the art will appreciate that the disclosed embodiments and examples should not be construed as limiting. It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A method for creating a computer-based experience, the method comprising:
receiving at least one input file comprising design information regarding a computer-based experience;
automatically extracting the design information from the at least one input file;
automatically generating design components using the design information; and
creating, using the design components, a customized computer-based experience.

2. The method of claim 1, wherein the computer-based experience comprises a game, a video, or an informational presentation.

3. The method of claim 1, wherein the computer-based experience is configured to be engaged by individuals using their computing devices via the internet.

4. The method of claim 1, wherein the design components comprise one or more of the following: image components, scalable vector graphic components, text components, tween components, animation components, physics components, and augmented reality components.

5. The method of claim 1, wherein automatically generating the design components comprises automatically creating at least one spritesheet comprising the design components.

6. The method of claim 1, wherein creating the customized computer-based experience comprises automatically generating computer code for the computer-based experience configured to utilize the extracted design information.

7. The method of claim 6, further comprising saving the computer code for later use as a template of a computer-based experience.

8. The method of claim 1, wherein creating the customized computer-based experience comprises automatically generating an initial computer-based experience based on a template selected by a user, and setting up a user interface for the user to use in modifying the initial computer-based experience to generate the customized computer-based experience.

9. The method of claim 8, wherein the user interface is configured to show an instant preview of changes made to the computer-based experience.

10. The method of claim 1, further comprising providing a URL for disseminating the customized computer-based experience so that individuals can access the customized computer-based experience.

11. A computer system for creating a computer-based experience, the computer system comprising:
at least one processor in operative communication with one or more user computing devices via the internet and in operative communication with one or more individual computing devices configured to access the computer-based experience, the one or more user computing devices configured to provide user input to the at least one processor while creating the computer-based experience; and
at least one memory device in operative communication with the at least one processor and operative to store information to be used by the at least one processor and/or generated by the at least one processor and to provide the stored information to the at least one processor, the at least one processor operative to:
receive at least one input file comprising design information regarding an initial computer-based experience;
automatically extract the design information from the at least one input file;
automatically generate design components using the design information; and
create, using the design components, a customized computer-based experience.

12. Non-transitory computer storage having stored thereon instructions that, when executed by a computer system cause the computer system to:
receive at least one input file comprising design information regarding an initial computer-based experience;
automatically extract the design information from the at least one input file;
automatically generate design components using the design information; and
create, using the design components, a customized computer-based experience.
